(19) United States
(12) Patent Application Publication
(10) Pub. No.: US 2010/0249990 A1
(43) Pub. Date: Sep. 30, 2010

(54) AUTOMATIC SHELF STOCKING APPARATUS AND RESTOCKING METHOD THEREOF

(75) Inventors: Chih-Chung Tsao, Chu-Nan (TW); Shan-Ju Lin, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/720,648

(22) Filed: Mar. 9, 2010

(30) Foreign Application Priority Data
Mar. 30, 2009 (CN) 200910301204.8

(51) Int. Cl. G06F 7/00

(52) U.S. Cl. 700/218; 700/230

(57) ABSTRACT

An automatic shelf stocking apparatus, which restocks goods onto a product shelf, includes a detection device, a communication device and a restocking device. The detection device determines whether a current stock of goods on the product shelf is less than a predetermined preferred stock value. The communication device outputs a restock instruction if the current stock is less than the preferred stock value. The restocking device prepares goods for restock following receipt of the restock instruction, and delivers the prepared restock goods to the product shelf.

### BACKGROUND

1. Technical Field

The present application is related to shelf stocking, and more particularly to an automatic shelf stocking apparatus and restocking method thereof, which can for example supply goods onto a product shelf in a supermarket.

2. Description of Related Art

In retail environments, shelf stocks must be constantly monitored and attended to by staff, in order that customers can locate desired items.

However, as with other manpower-based functions, consistency is difficult to maintain. Therefore, an automatic shelf stocking apparatus which can eliminate or mitigate the described limitations is needed.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a functional diagram of an automatic shelf stocking apparatus according to a first embodiment of the disclosure.

FIG. 2 is a diagram of an arrangement of an infrared detector of a detection device of the automatic shelf stocking apparatus of FIG. 1 at a product shelf.

FIG. 3 is a diagram of an arrangement of a pressure detector of the detection device of the automatic shelf stocking apparatus of FIG. 1 at the product shelf.

FIG. 4 is a functional diagram of an automatic shelf stocking apparatus according to a second embodiment of the disclosure.

FIG. 5 is a functional diagram of an automatic shelf stocking apparatus according to a third embodiment of the disclosure.

FIG. 6 is a functional diagram of an automatic shelf stocking apparatus according to a fourth embodiment of the disclosure.

FIG. 7 is a diagram of an arrangement of a delivery device of the automatic shelf stocking apparatus of FIG. 6 at a product shelf, with the delivery device including a guide track.

FIG. 8 is similar to FIG. 7, but showing an arrangement of a delivery device of an automatic shelf stocking apparatus of a first variation of the automatic shelf stocking apparatus of FIG. 6, at the product shelf, with the delivery device including a conveyer.

FIG. 9 is similar to FIG. 7, but showing an arrangement of a delivery device of an automatic shelf stocking apparatus of a second variation of the automatic shelf stocking apparatus of FIG. 6, at the product shelf, with the delivery device including both a guide track and a conveyer.

FIG. 10 is a functional diagram of an automatic shelf stocking apparatus according to a fifth embodiment of the disclosure.

FIG. 11 is a flow chart of a restocking method of an automatic shelf stocking apparatus of the disclosure.

### DETAILED DESCRIPTION

Reference will now be made to the drawings to describe various inventive embodiments of the present disclosure in detail, wherein like numerals refer to like elements throughout.

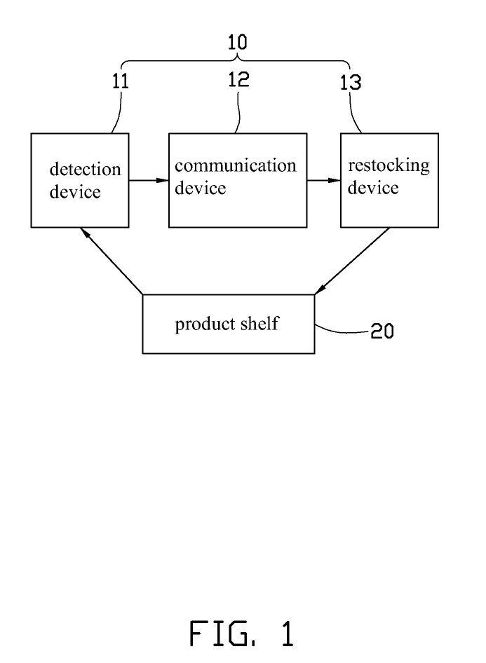

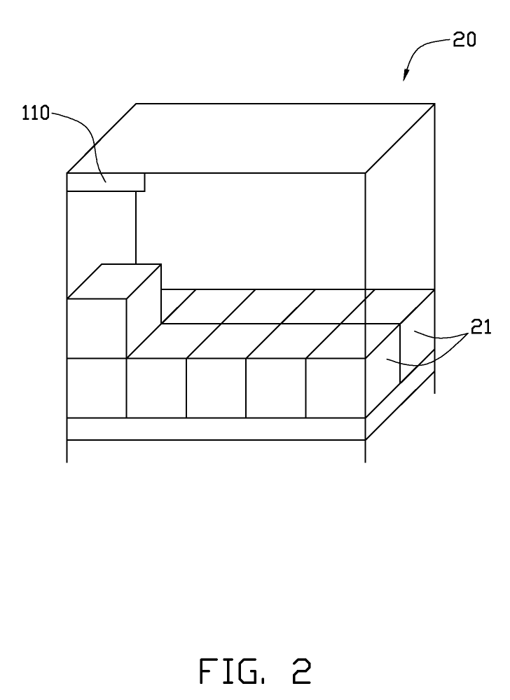

Referring to FIGS. 1 and 2, an automatic shelf stocking apparatus 10 according to the first embodiment of the disclosure includes a detection device 11, a communication device 12 and a restocking device 13.

The detection device 11 compares the current stock of goods 21 on the product shelf 20 with a predetermined preferred stock value. The predetermined preferred stock value is stored in the detection device 11. The value may be the maximum amount of goods that the product shelf 20 is capable of supporting or the ideal amount based on a particular requirement.

In the embodiment, the detection device 11 includes an infrared detector 110 disposed on the product shelf 20 (shown in FIG. 2). The infrared detector 110 detects and determines the stacked height and/or row/column count of the goods 21 on the product shelf 20 so that the detection device 11 can calculate the current stock of the goods 21. As should be noted, the infrared detector 110 is not limited to being disposition on the product shelf 20, and can alternatively be disposed adjacent to the product shelf 20.

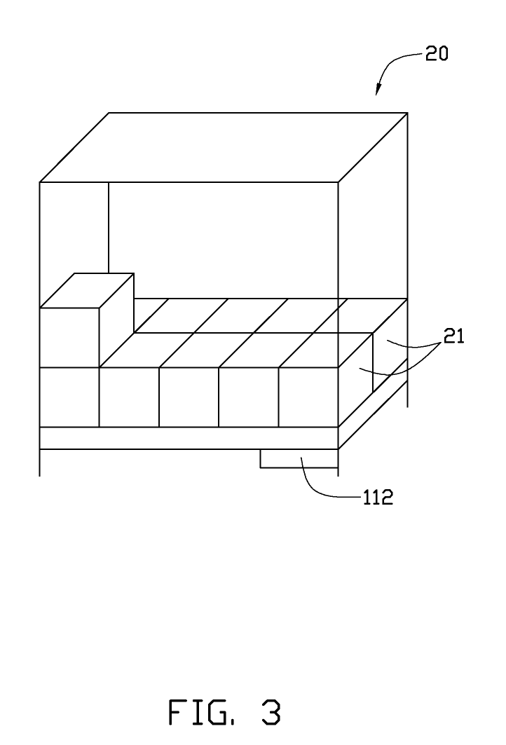

Referring to FIG. 3, the detection device 11 further includes a pressure detector 112 disposed on the surface of the product shelf 20. The pressure detector 112 detects the weight of goods 21 on the product shelf 20, thereby enabling the detection device 11 to calculate the current stock of the goods 21 on the product shelf 20 by comparing the detection result with the weight of a single good 21.

The communication device 12 outputs a restock instruction when the detection device 11 obtains a detection result indicating that the current stock of the goods 21 on the product shelf 20 is less than the predetermined preferred stock. In the embodiment, the communication device 12 can be disposed on the product shelf 20 or the restocking device 13.

The restocking device 13, upon receipt of the restock instruction, assembles goods 21 for restock and delivers the goods 21 to the product shelf 20 until the current stock equals the predetermined preferred stock value. A plurality of elements, which may be stored in the restocking device 13, participate in restocking preparation and delivery. Here, the restocking device 13 has an exit (not shown), through which the prepared restock order is passed to the product shelf 20 directly.

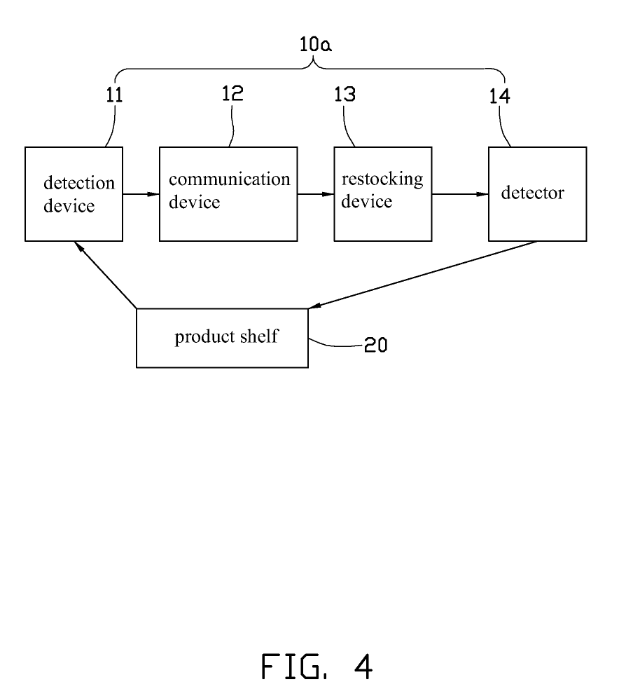

Referring to FIG. 4, this is a functional diagram of an automatic shelf stocking apparatus according to the second embodiment of the disclosure. Compared to the first embodiment, the automatic shelf stocking apparatus 10a further includes a detector 14. The detector 14 ensures that the goods are intact following restocking preparation. The intact goods are then delivered to the product shelf 20, and any non-intact goods are removed and may be placed in a recycle system.

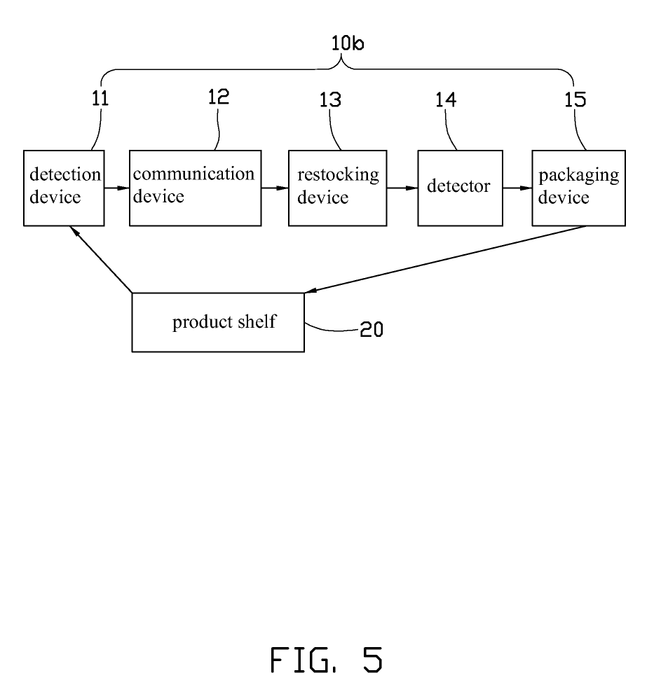

Referring to FIG. 5, this is a functional diagram of an automatic shelf stocking apparatus according to the third embodiment of the disclosure. Compared to the second embodiment, the automatic shelf stocking apparatus 10b further includes a packaging device 15. The packaging device 15 packages goods deemed intact by the detector 14, and delivers the packaged goods to the product shelf 20.

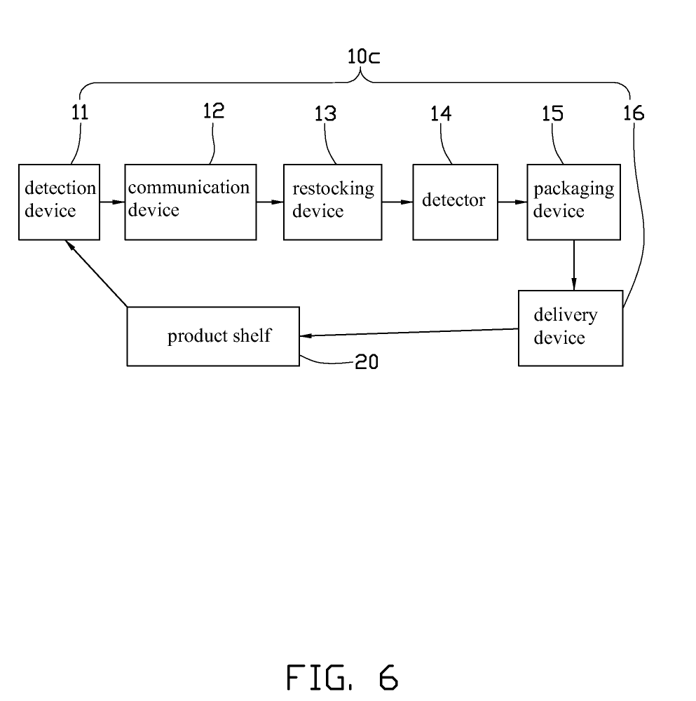

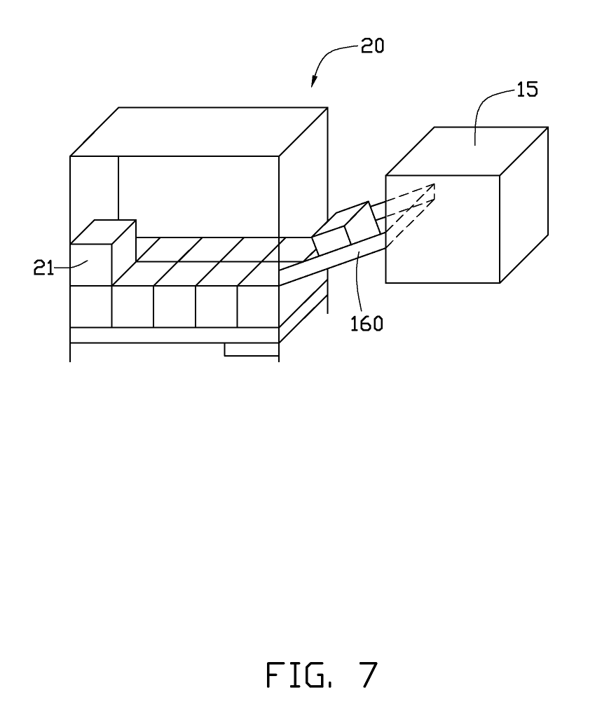

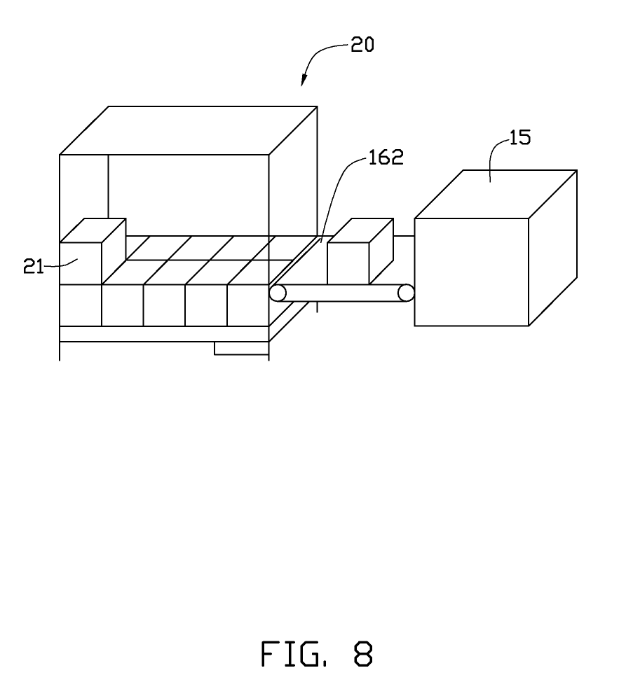

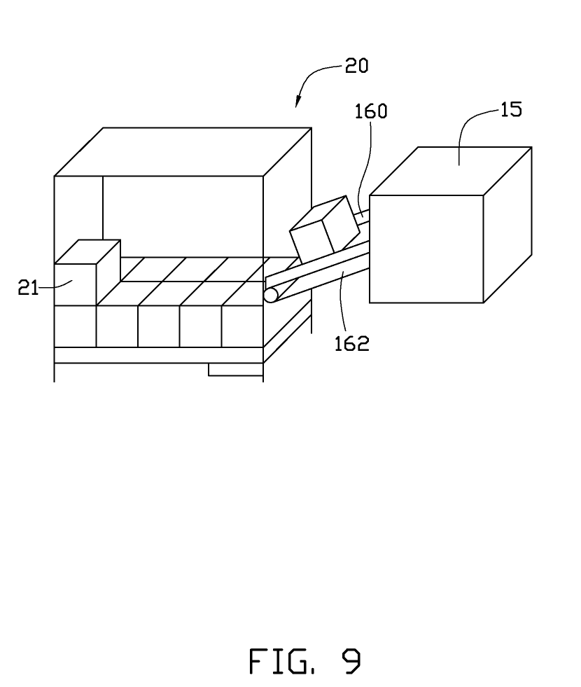

Referring to FIG. 6, this is a functional diagram of an automatic shelf stocking apparatus according to the fourth embodiment of the disclosure. Compared to the third embodiment, the automatic shelf stocking apparatus 10c further includes a delivery device 16. The delivery device 16 transports the packaged goods from the packaging device 15 to the product shelf 20. As shown in FIG. 7, the delivery device 16 can include a guide track 160 of a predetermined grade, by means of which the packaged goods can slide directly to the product shelf 20. Referring to FIG. 8, the delivery device 16 can instead include a conveyer 162 along which packaged goods are conveyed to the product shelf 20. Referring to FIG. 9, it should be noted that in still another example, the guide track 160 can be deployed in cooperation with the conveyer 162 to transport the goods. In this last embodiment, the conveyer 162 is positioned on an underside of the guide track 160, and the packaged goods are capable of moving along the guide track 160 to the product shelf 20 by at least one of sliding along the guide track 160 and propulsion by the conveyer 162.

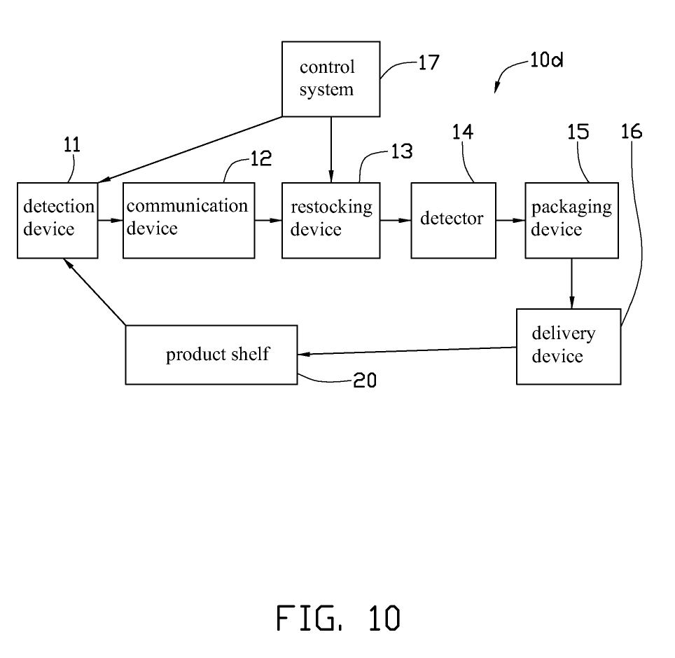

Referring to FIG. 10, an automatic shelf stocking apparatus 10d further includes a control system 17. The control system 17 can disable the detection device 11 and direct the restocking device 13 to simply prepare the restock in accordance with a particular requirement. Automatic detection of the current stock can be restored when the control system 17 is shut off or the detection device 11 is enabled.

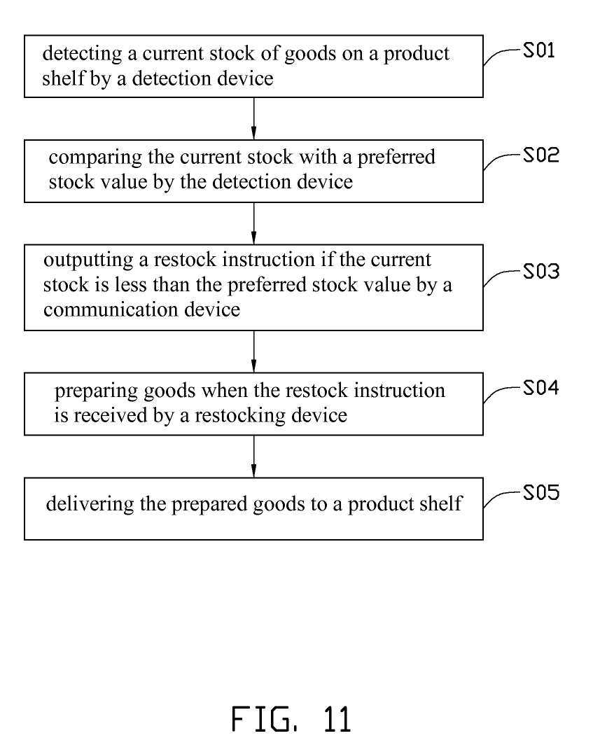

Referring to FIG. 11, a restocking method is applied with an automatic shelf stocking apparatus. The automatic shelf stocking apparatus is basically the same as the above embodiments. The restocking method includes steps S01-S05. Step S01 is detecting a current stock of goods on a product shelf by a detection device. Step S02 is comparing the current stock with a preferred stock value by the detection device. Step S03 is outputting a restock instruction if the current stock is less than the preferred stock value by a communication device. Step S04 is preparing goods when the restock instruction is received by a restocking device. Step S05 is delivering the prepared goods to a product shelf.

In alternative embodiment, the restocking method further includes determining whether the prepared restock goods are intact by a detector; packaging the intact goods by a packaging device; and transporting the packaged goods to the product shelf by a delivery device.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of the present invention to the full extent indicated by the broad general meaning of the terms in which the appended claims are expressed.

What is claimed is:

1. An automatic shelf stocking apparatus for restocking goods onto a product shelf, the apparatus comprising:
a detection device configured for determining whether a current stock of goods is less than a predetermined preferred stock value;
a communication device configured for outputting a restock instruction if the current stock is less than the preferred stock value; and
a restocking device configured for preparing goods for restocking following receipt of the restock instruction, and delivering the prepared goods to the product shelf.

2. The apparatus of claim 1, wherein the restocking device is configured for delivering the prepared goods to the product shelf until the current stock equals the predetermined preferred stock value.

3. The apparatus of claim 1, wherein the detection device comprises an infrared detector configured for detecting and calculating at least one of the stacked height, the row count, and the column count of the goods on the product shelf, whereby the detection device can ascertain whether the current stock of goods on the product shelf is less than or equal to the predetermined preferred stock value.

4. The apparatus of claim 1, wherein the detection device comprises a pressure detector configured for detecting the weight of goods on the product shelf, thereby enabling the detection device to determine the current stock of goods.

5. The apparatus of claim 1, further comprising a detector configured for determining whether the prepared restock goods are intact.

6. The apparatus of claim 5, further comprising a packaging device configured for packaging the intact goods.

7. The apparatus of claim 6, further comprising a delivery device configured for transporting the packaged goods from the packaging device to the product shelf.

8. The apparatus of claim 7, wherein the delivery device comprises a guide track of a predetermined grade extending from the packaging device to the product shelf, and the packaged goods are capable of sliding along the guide track to the product shelf.

9. The apparatus of claim 7, wherein the delivery device comprises a guide track extending from the packaging device to the product shelf, and a conveyer positioned on an underside of the guide track, and the packaged goods are capable of moving along the guide track to the product shelf by at least one of sliding along the guide track and propulsion by the conveyer.

10. The apparatus of claim 7, wherein the delivery device comprises a conveyer extending from the packaging device to the product shelf, the conveyor configured for propelling the packaged goods to the product shelf.

11. The apparatus of claim 1, further comprises a control system capable of disabling the detection device so as to directly control the restocking device to perform restocking on demand.

12. A restocking method, comprising:
detecting a current stock of goods on a product shelf, by a detection device;
comparing the current stock with a predetermined preferred stock value, by the detection device;
outputting a restock instruction if the current stock is less than the preferred stock value, by a communication device;
preparing goods when the restock instruction is received, by a restocking device; and
delivering the prepared goods to the product shelf.

13. The restocking method of claim 12, wherein the preparing of the goods comprises:
determining whether the prepared goods are intact, by a detector;
packaging the intact goods, by a packaging device; and
transporting the packaged goods to the product shelf, by a delivery device.

14. The restocking method of claim 13, wherein the packaged goods are transported to the product shelf by a guide track of the delivery device.

15. The restocking method of claim 13, wherein the packaged goods are transported to the product shelf by a conveyer of the delivery device.
